(19) United States
(12) Patent Application Publication
(10) Pub. No.: US 2006/0082070 A1
(43) Pub. Date: Apr. 20, 2006

(54) Combination seal

(76) Inventors: Hideo Mizuta, Okayama (JP); Hironori Yamamoto, Okayama (JP); Masanori Tomioka, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/290,441

(22) Filed: Dec. 1, 2005

Related U.S. Application Data
(63) Continuation of application No. 10/899,156, filed on Jul. 27, 2004.
Application No. 10/899,156 is a continuation of application No. 10/405,239, filed on Apr. 3, 2003, now abandoned.

(30) Foreign Application Priority Data
Apr. 3, 2002 (JP) 2002-101838

(51) Int. Cl. F16J 15/34

(52) U.S. Cl. 277/353

(57) ABSTRACT

A combination seal is attached to a bearing comprising a fixed element and a rotating element which rotate relative to each other, so as to seal an inner side and an outer side of the bearing. The combination seal is comprised of a seal ring and a slinger. The seal ring is comprised of a reinforcing ring and an elastic seal supported by the reinforcing ring. A leading end side of the elastic seal, supported by the reinforcing ring extending toward the slinger, is brought into contact with a surface of the slinger, which is opposite to the seal ring, when the combination seal is attached to the bearing. During a combining work process, when combining the seal ring and the slinger to form the combination seal, a seal lip does not turn over and the seal lip can be held toward a predetermined direction without using a specific jig during the combining work process and without being particularly careful during performance of the combining work process.

This application is a continuation of U.S. application Ser. No. 10/899,156, filed Jul. 27, 2004, which is a Continuation of U.S. Ser. No. 10/405,239, filed Apr. 3, 2003.

### BACKGROUND OF THE INVENTION

1. Field of the Invention

The present invention relates to a combination seal attached to a bearing comprising a fixed element and a rotating element which rotate relative to each other. The combination seal seals an inner side and an outer side of the bearing. More particularly, the present invention relates to a combination seal mounted to a bearing of a wheel in a motor vehicle so as to seal an inner side of the bearing, with the combination seal having a rotation detecting apparatus for detecting rotation of front and rear wheels.

2. Description of the Related Art

With respect to the combination seal as described previously, various kinds thereof have been conventionally proposed.

A combination seal attached to a bearing comprising a fixed element and a rotating element which rotate relative to each other, with the combination seal sealing an inner side and an outer side of the bearing, is generally structured by combining a seal ring and a slinger, each having an L-shaped cross section.

The seal ring, having an L-shaped cross section, includes a seal ring side cylindrical portion fitted and fixed to a peripheral surface of the fixed element of the bearing, and a seal ring side flange portion extending from an end portion of the seal ring side cylindrical portion toward a side of the rotating element of the bearing in a radial direction.

The slinger, having an L-shaped cross section, includes a slinger side cylindrical portion fitted and fixed to a peripheral surface of the rotating element of the bearing, and a slinger side flange portion extending from an end portion of the slinger side cylindrical portion toward a side of the fixed element of the bearing in a radial direction.

In this combination seal, a leading end side of an elastic seal, which is supported by either the seal ring or the slinger, is in contact with an opposing surface of an opposing member, thereby preventing foreign materials from entering into an inner side of the bearing and preventing grease from leaking out from the inner side of the bearing.

In the combination seal mentioned above, a seal lip tends to turn over during a combining process, which combines the seal ring and slinger to form the combination seal. However, if the seal lip is turned over so that it is not held toward a predetermined direction, it is hard to achieve a secure seal performance, and it is impossible to achieve a desired operation and effect such as preventing foreign materials from entering into the inner side of the bearing and preventing grease from leaking out from the inner side of the bearing.

Accordingly, it is necessary to carefully perform a combining work so that the seal lip does not turn over during this combining work process, and in some cases, it is necessary to pay attention and use a specific jig, such as pressing jig, so that the seal lip does not turn over during the combining work process.

Furthermore, in this conventional combination seal, the combination seal is assembled carefully in the manner mentioned above, and the combination seal is attached carefully to the bearing in order to prevent the seal lip from being turned over. To do this, it is necessary to provide a portion, which can make it possible to press the seal ring and the slinger into the inner side of the bearing simultaneously with when the combination seal is attached to the bearing.

A gap formed between a leading end portion of the slinger side flange portion in the radial direction and a peripheral surface of the fixed element, which is opposite to the rotating element is generally used as the portion, which can make it possible to press the seal ring and the slinger into the inner side of the bearing simultaneously when the combination seal is attached to the bearing.

That is, the portion described previously is generally obtained by making a size of the slinger side flange portion in the radial direction smaller than an interval between the opposing fixed element and rotating element so that a gap is formed between the leading end portion of the slinger side flange portion in the radial direction and the peripheral surface of the fixed element, which is opposite to the rotating element, at a time of attaching the combination seal to the bearing. The gap, formed as described previously, between the leading end portion of the slinger side flange portion in the radial direction and the peripheral surface of the fixed element, which is opposite to the rotating element, is used as the portion described previously, which can make it possible to press the seal ring and the slinger into the inner side of the bearing simultaneously with when the combination seal is attached to the bearing. That is, this structure is made such that, when a combined seal ring and slinger are pressed into the inner side of the bearing simultaneously, the seal ring is pressed via the gap mentioned above.

When a combination seal is attached to a bearing of a wheel in a motor vehicle to seal an inner side of the bearing, and when the combination seal is employed along with a rotation detecting apparatus for detecting rotation of front and rear wheels, it is common to arrange an encoder on a slinger side flange portion.

Accordingly, when a combination seal is attached to a bearing of a wheel in a motor vehicle to seal an inner side of the bearing, and when it is intended to employ the combination seal along with a rotation detecting apparatus (encoder) for detecting rotation of front and rear wheels, there is no alternative but to apply a fixed limitation to a size of a slinger side flange portion in a radial direction due to formation of the gap mentioned above, and accordingly, there is no alternative but to limit an effective area of the encoder arranged on the slinger side flange portion.

If the effective area of the encoder can be increased, it is possible to improve reliability of detecting a rotation of the wheels, and it is possible to make large an output of a sensor, arranged close to and opposite to the encoder and sensing a pulse generated from the encoder so as to detect this rotation, large, so that this structure is advantageous.

### SUMMARY OF THE INVENTION

An object of the present invention is to solve problems of the conventional combination seal mentioned above and problems generated in a case of a conventional combination seal being attached to a bearing of a wheel in a motor vehicle to seal an inner side of the bearing, and when the conventional combination seal is employed along with a rotation detecting apparatus for detecting rotation of front and rear wheels.

That is, an object of the present invention is to provide a combination seal in which a seal lip does not turn over, and the seal lip can be held toward a predetermined direction, without using a specific jig during a combining work process, and without performing particularly careful combining work.

Furthermore, an object of the present invention is to provide a combination seal that can be attached to a bearing of a wheel in a motor vehicle to seal an inner side of the bearing, and that can be employed along with a rotation detecting apparatus (encoder) for detecting rotation of front and rear wheels, wherein an effective area of the encoder can be made larger.

In order to achieve the objects mentioned above, the combination seal proposed by the present invention is comprised as follows.

A combination seal 1, 18 in accordance with the present invention, is attached to a bearing, comprising a fixed element(for example, an outer ring 101) and a rotating element(for example, an inner ring 102), which rotate relative to each other, so as to seal an inner side and an outer side of the bearing.

The combination seal 1 is comprised of a seal ring 2 and a slinger 7.

The seal ring 2 is comprised of a reinforcing ring 5 and an elastic seal 6 supported by the reinforcing ring 5. The reinforcing ring 5 has an L-shaped cross section and comprises a seal ring side cylindrical portion 3 fitted and fixed to a peripheral surface of the fixed element of a bearing (for example, outer ring 101 of the bearing) and a seal ring side flange portion 4 extending from an end portion of the seal ring side cylindrical portion 3 toward a side of the rotating element in a radial direction.

The slinger 7 has an L-shaped cross section, and is comprised of a slinger side cylindrical portion 8 fitted and fixed to a peripheral surface of the rotating element of a bearing (for example, inner ring 102 of the bearing), and a slinger side flange portion 9 extending from an end portion of the slinger side cylindrical portion 8 toward a side of the fixed element in the radial direction.

The combination seal 1 is structured such that a leading end side of the elastic seal 6 extending toward the slinger 7 is brought into contact with a surface of the slinger 7, which is opposite to the seal ring 2, when it is attached to the bearing.

The elastic seal 6 supported by the reinforcing ring 5 of the seal ring 2 is equipped with a radial lip 11, an outer radial lip 12, and a side lip 13.

The radial lip 11 is structured, as illustrated in FIG. 1, such that the radial lip 11 extends obliquely in a radial direction toward the slinger side cylindrical portion 8 and in an axial direction toward the inner side of the bearing from a base end portion 10 supported by the seal ring side flange portion 4, and a leading end side of the radial lip is brought into contact with a peripheral surface of the slinger side cylindrical portion 8, which is opposite to the seal ring 2, when the seal ring 2 and the slinger 3 are combined and attached to the bearing.

The outer radial lip 12 is structured, as illustrated in FIG. 1, such that the outer radial lip 12 extends obliquely in a radial direction toward the slinger side cylindrical portion 8 and in an axial direction toward the outer side of the bearing from the base end portion 10 supported by the seal ring side flange portion 4, and a leading end side of the outer radial lip is brought into contact with a peripheral surface of the slinger side cylindrical portion 8, which is opposite to the seal ring 2, when the seal ring 2 and the slinger 7 are combined and attached to the bearing.

The side lip 13 is structured, as illustrated in FIG. 1, such that the side lip 13 is supported by the seal ring side flange portion 4, and extends obliquely in a radial direction toward the seal ring side cylindrical portion 3 and in an axial direction toward the outer side of the bearing, and a leading end side of the side lip is brought into contact with an inner peripheral surface of the slinger side flange portion 9 in an axial direction, when the seal ring 2 and the slinger 3 are combined and attached to the bearing.

In this case, in the combination seal 1, in accordance with the present invention, the elastic seal 6 described previously has the following characteristic structures and aspects.

When the seal ring 2 and the slinger 7 are moved close to each other to be combined, as shown by arrows 14 and 15 in FIG. 2, and as illustrated in FIG. 3(a), and when the leading end side of the radial lip 11 is first brought into contact with the peripheral surface of the slinger side cylindrical portion 8, which is opposite to the seal ring, the leading end side of the outer radial lip 12 is not in contact with the peripheral surface of the slinger side cylindrical portion 8, which is opposite to the seal ring 2, or is in light contact therewith which is not illustrated.

When the leading end side of the radial lip 11 slides on the peripheral surface of the slinger side cylindrical portion 8, which is opposite to the seal ring 2, by moving the seal ring 2 closer to the slinger 7, in correspondence thereto, the leading end side of the outer radial lip 12 moves toward the peripheral surface of the slinger side cylindrical portion 8, which is opposite to the seal ring 2, around the base end portion 10, as shown by an arrow 16 in FIG. 3(a). That is, the radial lip 11 and the outer radial lip 12 carry out a so-called seesaw function around the base end portion 10.

Furthermore, only after the leading end side of the radial lip 11 comes into contact with a regular amount of exposed thread with respect to the peripheral surface of the slinger side cylindrical portion 8, which is opposite to the seal ring 2 in an attaching state as illustrated in FIG. 1, the leading end side of the outer radial lip 12 comes into contact with a regular amount of exposed thread with respect to the peripheral surface of the slinger side cylindrical portion 8, which is opposite to the seal ring 2 in the attaching state as illustrated in FIG. 1.

Since the combination seal, in accordance with the present invention, has the characteristic structure as mentioned above, the outer radial lip 12 does not turn over during performance of combining work as illustrated in FIGS. 2 and 3(a) without having to use a specific jig or being specifically careful during performance of the combining work.

Accordingly, in a case of attaching the combination seal to a bearing, in accordance with the present invention, the slinger can be mounted after the seal ring is first mounted. That is, the seal ring and the slinger constituting the combination seal of the present invention can be separately attached to the bearing.

As mentioned above, in the conventional combination seal it is necessary to provide a portion, which can make it possible to press the seal ring and the slinger into the inner side of the bearing simultaneously with when the combination seal is attached to the bearing, in order to attach a previously assembled combination seal to the bearing while preventing the seal lip from being turned over. And, in the conventional combination seal, for example, the gap formed between the leading end portion in the radial direction of the slinger side flange portion and the peripheral surface of the fixed element, which is opposite to the rotating element when the combination seal is attached to the bearing, is used as this portion.

However, as mentioned above, since the seal ring and the slinger constituting the combination seal of the present invention can be separately attached to the bearing, there is no requirement for the portion described previously, which can make it possible to press the seal ring and the slinger into the inner side of the bearing simultaneously with when the combination seal is attached to the bearing, in order to attach a previously assembled combination seal to the bearing while preventing the seal lip from being turned over.

As a result, in a case of employing the combination seal, in accordance with the present invention, as the combination seal is mounted to a bearing of a wheel in a motor vehicle so as to seal an inner side of the bearing, and is employed along with a rotation detecting apparatus (encoder) for detecting rotation of front and rear wheels, it is possible to expand an area of the encoder to a limit between an outer ring and an inner ring of the bearing, and it is possible to increase an effective area of the encoder.

Accordingly, in a case of employing the combination seal, in accordance with the present invention, as the combination seal is mounted to a bearing of a wheel in a motor vehicle so as to seal an inner side of the bearing, and is employed along with a rotation detecting apparatus (encoder) for detecting rotation of front and rear wheels, it is possible, for example, to employ a structure in which an encoder 17 is mounted to an outer side surface in an axial direction of slinger side flange portion 9.

In accordance with the combination seal of the present invention, the outer radial lip does not turn over during performance of combining work, which combines the seal ring and the slinger to form the combination seal of the present invention, even if a specific jig, such as pressing jig, is not used or the performance of combining work is not performed with specific care.

Accordingly, it is possible to separately attach the seal ring and the slinger, which comprise the combination seal, to a bearing and to assemble the seal ring and slinger into a combination seal.

Furthermore, if assembled and combined in this manner, it is possible to bring not only the outer radial lip but also the radial lip and the side lip into contact with the inner side surface of the slinger with a regular amount of exposed thread, and to hold these lips toward a predetermined direction.

Furthermore, in accordance with the combination seal of the present invention, in a case that a combination seal is mounted to a bearing of a wheel in a motor vehicle so as to seal an inner side of the bearing, and is employed along with a rotation detecting apparatus (encoder) for detecting rotation of front and rear wheels, it is possible to increase an effective area of the encoder.

### BRIEF DESCRIPTION OF THE DRAWINGS

FIG. 1 is a cross sectional view showing a state in which a combination seal, in accordance with the present invention, is attached to a bearing;

FIG. 2 is a cross sectional view describing a state in which the combination seal illustrated in FIG. 1 is combined;

FIG. 3(a) is a cross sectional view describing a state in which another combination seal, in accordance with the present invention, is combined; and

FIG. 3(b) is a cross sectional view of a state in which the combination seal illustrated in FIG. 3(a) is combined.

### DETAILED DESCRIPTION OF THE PREFERRED EMBODIMENTS

### Embodiment 1

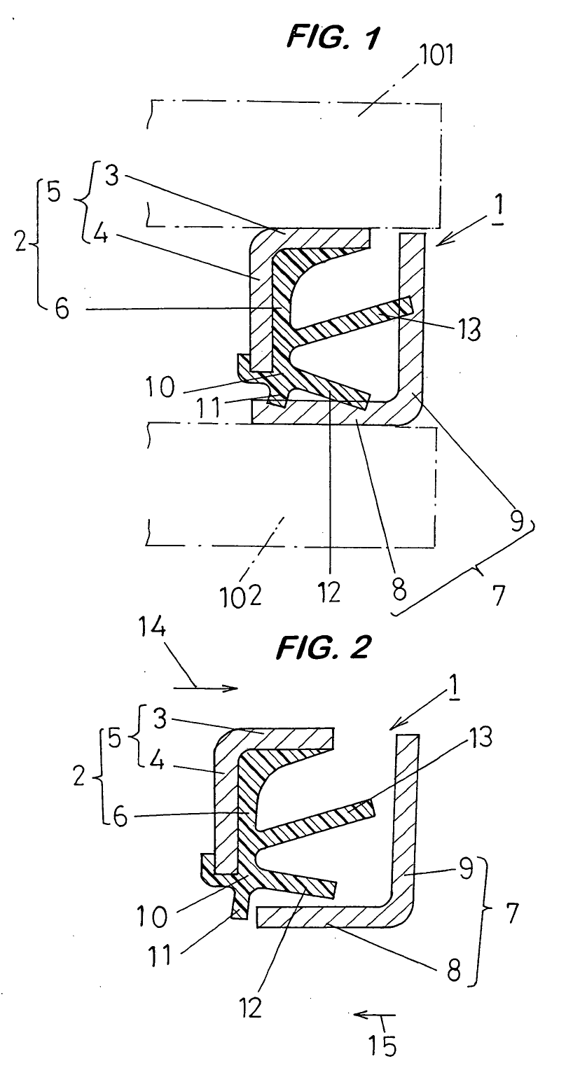

FIG. 1 is a cross sectional view showing a state in which a combination seal 1, in accordance with the present invention, is attached to a bearing. In FIG. 1, the bearing is comprised of a rotating inner ring 102 and an outer ring 101. The outer ring 101 corresponds to a fixed ring. And, an inner side of the bearing and an outer side of the bearing are sealed by the combination seal 1.

The combination seal 1 is comprised of a seal ring 2 and a slinger 7. The seal ring 2 comprises a reinforcing ring 5 made of metal and having an L-shaped cross sectional shape, and an elastic seal 6 supported by the reinforcing ring 5. The slinger 7 is also made of metal and has an L-shaped cross sectional shape.

In the embodiment illustrated in FIG. 1, the reinforcing ring 5 of the seal ring 2 is comprised of a seal ring side cylindrical portion 3 fitted and fixed to an inner peripheral surface of the outer ring 101, and a seal ring side flange portion 4 extending from an end portion of the seal ring side cylindrical portion 3 toward a side of the inner ring 102 in a radial direction. And, the slinger 7 is comprised of a slinger side cylindrical portion 8 fitted and fixed to an outer peripheral surface of the inner ring 102, and a slinger side flange portion 9 extending from an end portion of the slinger side cylindrical portion 8 toward a side of the outer ring 101 in a radial direction.

The elastic seal 6 is made of a known material in this technical field such as a synthetic rubber, an elastomer or the like, and is attached to the reinforcing ring 5 so as to be supported thereby.

In a state in which the combination seal 1 is combined as shown in FIG. 1, a leading end side of the elastic seal 6 extending toward a side of the slinger 7 is structured such that it is in contact with a surface of the slinger 7, which is opposite to the seal ring 2. And, in the combination seal 1, in accordance with the present invention, in a state in which the combination seal 1 is combined as shown in FIG. 1, leading end sides of a radial lip 11, an outer radial lip 12, and a side lip 13 equipped on the elastic seal 6 are respectively in contact with the surface of the slinger 7, which is opposite to the seal ring 2.

The radial lip 11 is structured, as illustrated in FIG. 1, such that the radial lip 11 extends obliquely in a radial direction toward the slinger side cylindrical portion 8 and in an axial direction toward the inner side of the bearing (the left side in FIG. 1) from a base end portion 10, supported by the seal ring side flange portion 4, and the leading end side of the radial lip 11 is brought into contact with a peripheral surface (an outer peripheral surface) of the slinger side cylindrical portion 8, which is opposite to the seal ring 2, when the seal ring 2 and the slinger 3 are combined and attached to the bearing.

Since the radial lip 11 is inclined, as illustrated in FIG. 1, and is in contact with the inner peripheral surface of the slinger side cylindrical portion 8, it is possible to effectively prevent grease from leaking out from the inner side of the bearing.

The outer radial lip 12 is structured, as illustrated in FIG. 1, such that the outer radial lip 12 extends obliquely in a radial direction toward the slinger side cylindrical portion 8 and in an axial direction toward the outer side of the bearing (the right side in FIG. 1) from the base end portion 10, supported by the seal ring side flange portion 4, and the leading end side of the outer radial lip 12 is brought into contact with a peripheral surface (an outer peripheral surface) of the slinger side cylindrical portion 8, which is opposite to the seal ring 2, when the seal ring 2 and the slinger 7 are combined and attached to the bearing.

Furthermore, the side lip 13 is structured, as illustrated in FIG. 1, such that the side lip 13 is supported by the seal ring side flange portion 4 and extends obliquely in a radial direction toward the seal ring side cylindrical portion 3 and in an axial direction toward the outer side of the bearing (the right side in FIG. 1), and the leading end side of the side lip 13 is brought into contact with an inner peripheral surface of the slinger side flange portion 9 in an axial direction, when the seal ring 2 and the slinger 3 are combined and attached to the bearing.

Since a contact aspect between the outer radial lip 12 and the side lip 13, and an inner side surface of the slinger 7 is an aspect as mentioned above and illustrated in FIG. 1, it is possible to effectively prevent foreign material from entering into the inner side of the bearing from the outer side of the bearing.

When the seal ring 2 and the slinger 7 are combined by moving the seal ring 2 and the slinger 7 close to each other, as shown by arrows 14 and 15 in FIG. 2, so as to obtain the combination seal 1, in accordance with the present invention, the combination seal 1 of the present invention employs the following structures and aspects in order to prevent the outer radial lip 12 from being turned over.

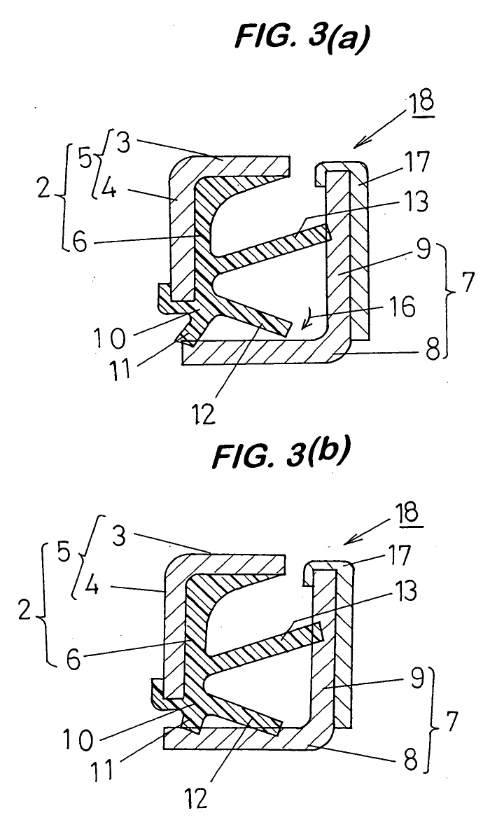

Namely, when the seal ring 2 and the slinger 7 are moved close to each other from the state illustrated in FIG. 2, and when the leading end side of the radial lip 11 is first brought into contact with the outer peripheral surface of the slinger side cylindrical portion 8, as shown in FIG. 3(a), the leading end side of the outer radial lip 12 is not yet in contact with the outer peripheral surface of the slinger side cylindrical portion 8.

Next, when the seal ring 2 and the slinger 7 are moved close to each other from the state illustrated in FIG. 3(a), the leading end side of the radial lip 11 slides on the outer peripheral surface of the slinger side cylindrical portion 8, and in correspondence thereto, the leading end side of the outer radial lip 12 moves toward the outer peripheral surface of the slinger side cylindrical portion 8, as shown by an arrow 16 in FIG. 3(a). That is, the radial lip 11 and the outer radial lip 12 perform a so-called seesaw motion around the base end portion 10, and the leading end side of the outer radial lip 12 rotates around the base end portion 10 and moves toward the outer peripheral surface of the slinger side cylindrical portion 8.

Furthermore, only after the leading end side of the radial lip 11 comes into contact with a regular amount of exposed thread with respect to the outer peripheral surface of the slinger side cylindrical portion 8, in an attaching state as illustrated in FIG. 1, the leading end side of the outer radial lip 12 comes into contact with a regular amount of exposed thread with respect to the outer peripheral surface of the slinger side cylindrical portion 8, in the attaching state as illustrated in FIG. 1.

Accordingly, during a combining process of the combination seal 1 of the present invention, when combining the seal ring 2 and the slinger 7 by moving them close to each other, as shown by arrows 14 and 15 in FIG. 2, the leading end side of the outer radial lip 12 does not come into contact with and slide on the outer peripheral surface of the slinger side cylindrical portion 8 very strongly, so that the outer radial lip 12 does not turn over.

That is, the outer radial lip 12 does not turn over during combining work from the state illustrated in FIG. 2 to the combined state as shown in FIGS. 1 and 3(b), for example, via the state as illustrated in FIG. 3(a), without having to use a specific jig and without being specifically careful during performing the combining work.

As described previously, the contact aspects between the radial lip 11, the outer radial lip 12, and the side lip 13, and the inner side surface of the slinger 7 becomes as shown in FIGS. 1 and 3(b) in the combined state without using a specific jig and without being specifically careful during performing combining work. The contact aspect can be held in a predetermined inclined direction which is planned for securing a sealing property and with a regular amount of exposed thread. And, it is possible to effectively achieve prevention of foreign materials from entering into the inner side of a bearing from the outer side of the bearing, and prevention of grease from leaking out from the inner side of the bearing to the outer side of the bearing.

In the present invention, the structure and the aspect may be modified such that, although the illustration is omitted, the leading end side of the outer radial lip 12 is in light contact with the outer peripheral surface of the slinger side cylindrical portion 8 when the seal ring 2 and the slinger 7 move close to each other from the state illustrated in FIG. 2, and the leading end side of the radial lip 11 is first brought into contact with the outer peripheral surface of the slinger side cylindrical portion 8 as shown in FIG. 3(a).

In this modified structure and aspect, in the same manner as mentioned above, when the leading end side of the radial lip 11 slides on the outer peripheral surface of the slinger side cylindrical portion 8, the leading end side of the outer radial lip 12 moves toward the outer peripheral surface of the slinger side cylindrical portion 8 around the base end portion 10 in correspondence thereto, as shown by the arrow 16 in FIG. 3(a). And, only after the leading end side of the radial lip 11 comes into contact with a regular amount of exposed thread with respect to the outer peripheral surface of the slinger side cylindrical portion 8, in the attaching state as illustrated in FIG. 1, the leading end side of the outer radial lip 12 comes into contact with a regular amount of exposed thread with respect to the outer peripheral surface of the slinger side cylindrical portion 8, in the attaching state as illustrated in FIG. 1.

Therefore, in accordance with the modified aspect mentioned above, during a combining process, when combining the seal ring 2 and the slinger 7 to form the combination seal 1 of the present invention by moving the seal ring 2 and the slinger 7 close to each other as shown by the arrows 14 and 15 in FIG. 2, the leading end side of the outer radial lip 12 does not strongly contact the outer peripheral surface of the slinger side cylindrical portion 8, and the leading end side of the outer radial lip 12 does not strongly slide on the outer peripheral surface of the slinger side cylindrical portion 8, so that the outer radial lip 12 does not turn over.

As mentioned above, the combination seal 1 of the present invention can be made in the combined state shown in FIGS. 1 and 3(b) without the outer radial lip 12 turning over, even if a specific jig, such as pressing jig, is not used and a combining work process is not conducted with specific care.

Therefore, when a combination seal 1 of the present invention is attached to a bearing, first the seal ring 2 can be mounted, and then the slinger 7 can be mounted. That is, the seal ring 2 and the slinger 7 can be separately attached to the bearing.

As mentioned above, in the conventional combination seal it is necessary to provide a portion, which can make it possible to press the seal ring and the slinger into the inner side of the bearing simultaneously when the combination seal is attached to the bearing in order to attach the previously assembled combination seal to the bearing while preventing the seal lip from being turned over.

However, as mentioned above, since the seal ring 2 and the slinger 7, comprising the combination seal 1 of the present invention, can be separately attached to the bearing as described previously, there is no requirement for the portion described previously, which can make it possible to press the seal ring and the slinger into the inner side of the bearing simultaneously when the combination seal is attached to the bearing, in order to attach the previously assembled combination seal to the bearing while preventing the seal lip from being turned over. And, the combination seal 1 of the present invention can be made in the combined state shown in FIGS. 1 and 3(b) without the outer radial lip 12 turning over, even if a specific jig, such as pressing jig, is not used and even if the combining work process is not conducted with specific care. So that, as illustrated in FIG. 1, it is possible to move an outer peripheral edge of the slinger side flange portion 9 close to the inner peripheral surface of the outer ring 101.

Accordingly, it is possible to move the leading end portion of the slinger side flange portion 9, which is opposite to the outer ring 101, close to the inner peripheral surface of the outer ring 101 as illustrated in FIG. 1. Accordingly, it is possible to make a width, expressed by a vertical direction of the slinger side flange portion 9 in FIG. 1, to a desired size without specifically increasing an interval between the inner ring 102 and the outer ring 101. Therefore, it is possible to save space of a bearing portion.

Furthermore, since it is possible to move the leading end portion of the slinger side flange portion 9, which is opposite to the outer ring 101, close to the inner peripheral surface of the outer ring 101 as illustrated in FIG. 1, which secures a larger width of the slinger side flange portion 9, expressed by the vertical direction in FIG. 1, it is possible to secure a large degree of freedom for the side lip 13.

Furthermore, in a case of mounting an encoder to the slinger side flange portion 9, when mounting the combination seal 1 of the present invention to a bearing of a wheel in a motor vehicle to seal an inner side of the bearing, and when employing the combination seal 1 along with a rotation detecting apparatus for detecting rotation of front and rear wheels, it is possible to increase an effective area of the encoder.

### Embodiment 2

FIGS. 3(a) and 3(b) describe another embodiment of a combination seal 18 in accordance with the present invention.

The combination seal 18 illustrated in FIGS. 3(a) and 3(b) expresses a case in which the combination seal is mounted to a bearing of a wheel in a motor vehicle to seal an inner side of the bearing, and is employed along with a rotation detecting apparatus for detecting rotation of front and rear wheels.

This embodiment is different from the embodiment illustrated in FIGS. 1 and 2 only in that an encoder 17 is mounted to an outer surface of the slinger side flange portion 9 in an axial direction. Other constructions, operations and effects of combination seal 18 illustrated in FIGS. 3(a) and 3(b) are the same as those of combination seal 1 illustrated in FIGS. 1 and 2. Accordingly, the same reference numerals are attached to common portions and a description thereof will be omitted.

The encoder 17, which is magnetized so that N poles and S poles appear alternately in a circumferential direction, is formed by mixing magnetic powders such as ferrite or the like into a rubber material, vulcanizing this mixture, and then magnetizing the mixture so that N poles and S poles appear alternately in a circumferential direction.

In the combination seal 18, in accordance with this embodiment, it is possible to mount the encoder 17 in a manner illustrated in FIG. 3(b), it is possible to expand the encoder to a limit between the outer ring 101 and inner ring 102 of a bearing, and it is possible to increase an effective area of the encoder 17.

In this case, in the embodiment illustrated in FIGS. 3(a) and 3(b), the structure is made such that one end side (an end portion in a side of outer ring 101) of the encoder 17 is mounted to an end portion of the slinger side flange portion 9 on a side of the outer ring 101.

However, the structure for mounting the encoder 17 to the outer side surface of the slinger side flange portion 9 in the axial direction is not limited to the embodiment mentioned above. For example, the encoder 17 can be bonded to the outer side surface of the slinger side flange portion 9 in the axial direction, or to integrally vulcanize the encoder 17 on the outer side surface of the slinger side flange portion 9 in the axial direction while expanding an outer peripheral edge of the encoder 17 close to an outer peripheral edge of the slinger side flange portion 9.

The preferred embodiments of the present invention are described above using the accompanying drawings. In the preferred embodiments described previously, respective structures, shapes, and relationships of arrangement described with reference to the accompanying drawings are only schematically shown for understanding the present invention. Accordingly, the present invention is not limited to the aspects described in the embodiments described previously, and can be modified to various aspects within a technical scope comprehended by the description in the appended claims.

What is claimed is:

1. A combination seal to be attached to a bearing having a fixed element and a rotatable element, which are to rotate relative to each other, so as to seal an inner side and an outer side of the bearing, comprising:
a seal ring including a reinforcing ring and an elastic seal supported by said reinforcing ring, said reinforcing ring having an L-shaped cross section defined by
(i) a seal ring side cylindrical portion to be fitted and fixed to a peripheral surface of the fixed element of the bearing, and
(ii) a seal ring side flange portion extending from an end portion of said seal ring side cylindrical portion in a radial direction toward a side of the rotatable element of the bearing, when said seal ring side cylindrical portion is fitted and fixed to the peripheral surface of the fixed element of the bearing,
with said elastic seal being supported by said seal ring side flange portion; and
a slinger having an L-shaped cross section defined by
(i) a slinger side cylindrical portion to be fitted and fixed to a peripheral surface of the rotatable element of the bearing, and
(ii) a slinger side flange portion extending from an end portion of said slinger side cylindrical portion in a radial direction toward a side of the fixed element of the bearing, when said slinger side cylindrical portion is fitted and fixed to the peripheral surface of the rotatable element of the bearing,
wherein said elastic seal includes a radial lip and an outer radial lip extending from a base end portion, and a side lip, and is constructed and arranged such that when said seal ring and said slinger are moved toward each other so as to be combined with one another,
(i) a leading end of said radial lip is brought into contact with a peripheral surface of said slinger side cylindrical portion, while a leading end of said outer radial lip is not in contact with the peripheral surface of said slinger side cylindrical portion or is in light contact therewith, then
(ii) said leading end of said radial lip slides on the peripheral surface of said slinger side cylindrical portion, while said leading end of said outer radial lip moves about said base end portion toward the peripheral surface of said slinger side cylindrical portion, and then
(iii) said leading end of said outer radial lip comes into firm contact with the peripheral surface of said slinger side cylindrical portion,
such that
(a) said radial lip extends from said base end portion in a radial direction obliquely toward said slinger side cylindrical portion and in an axial direction toward an inner side of the bearing when said seal ring side cylindrical portion is fitted and fixed to the peripheral surface of the fixed element of the bearing and when said slinger side cylindrical portion is fitted and fixed to the peripheral surface of the rotatable element of the bearing, while said leading end of said radial lip is in contact with the peripheral surface of said slinger side cylindrical portion,
(b) said outer radial lip extends from said base end portion in a radial direction obliquely toward the slinger side cylindrical portion and in an axial direction toward an outer side of the bearing when said seal ring side cylindrical portion is fitted and fixed to the peripheral surface of the fixed element of the bearing and when said slinger side cylindrical portion is fitted and fixed to the peripheral surface of the rotatable element of the bearing, while said leading end of said outer radial lip is in contact with the peripheral surface of said slinger side cylindrical portion, and
(c) said side lip extends in a radial direction obliquely toward a level at which said seal ring side cylindrical portion is positioned and in an axial direction toward the outer side of the bearing when said seal ring side cylindrical portion is fitted and fixed to the peripheral surface of the fixed element of the bearing and when said slinger side cylindrical portion is fitted and fixed to the peripheral surface of the rotatable element of the bearing, while a leading end of said side lip is in contact with an inner peripheral surface of said slinger side flange portion.

2. The combination seal according to claim 1, further comprising:
an encoder mounted to an outer side surface of said slinger side flange portion in an axial direction.

3. The combination seal according to claim 2, wherein said radial lip and said outer radial lip extend from said base end portion such that in the radial direction, prior to said seal ring and said slinger being combined with one another, said radial lip extends to a greater extent than does said outer radial lip.

4. The combination seal according to claim 3, wherein
said radial lip and said outer radial lip extend from said base end portion such that, prior to said seal ring and said slinger being combined with one another, said radial lip extends generally orthogonally to said outer radial lip.

5. The combination seal according to claim 1, wherein
said radial lip and said outer radial lip extend from said base end portion such that in the radial direction, prior to said seal ring and said slinger being combined with one another, said radial lip extends to a greater extent than does said outer radial lip.

6. The combination seal according to claim 5, wherein
said radial lip and said outer radial lip extend from said base end portion such that, prior to said seal ring and said slinger being combined with one another, said radial lip extends generally orthogonally to said outer radial lip.
